(19) United States
(12) Patent Application Publication
(10) Pub. No.: US 2023/0326086 A1
(43) Pub. Date: Oct. 12, 2023

(54) SYSTEMS AND METHODS FOR IMAGE AND VIDEO COMPRESSION

(71) Applicant: THE BOARD OF REGENTS OF THE UNIVERSITY OF TEXAS SYSTEM, Austin, TX (US)

(72) Inventors: Murat Can Cobanoglu, Houston, TX (US); Kevin Christopher VanHorn, Dallas, TX (US)

(21) Appl. No.: 18/298,893

(22) Filed: Apr. 11, 2023

Related U.S. Application Data
(60) Provisional application No. 63/329,826, filed on Apr. 11, 2022.

(51) Int. Cl. G06T 9/00; G06T 7/13; G06T 7/136

(52) U.S. Cl. CPC G06T 9/00; G06T 7/13; G06T 7/136; G06T 2207/20021

(57) ABSTRACT

Aspects of the present disclosure generally relate to systems and methods for image processing, and more specifically, for processing images or videos using different compression or decompression techniques. Certain aspects of the present disclosure are directed towards a method for image compression. The method generally includes: dividing an image into at least a first region and a second region, wherein the first region and the second region comprise irregular shaped regions, selecting a first compression technique to be applied to the first region and a second compression technique to be applied to the second region, the first compression technique being different than the second compression technique, and compressing the first region using the first compression technique and the second region using the second compression technique.

### CROSS-REFERENCE TO RELATED APPLICATION

This application claims priority to U.S. Provisional Patent Application No. 63/329,826, filed Apr. 11, 2022, and titled “SYSTEMS AND METHODS FOR IMAGE AND VIDEO COMPRESSION,” which is incorporated in its entirety herein by reference.

### BACKGROUND

### 1. Technical Field

Aspects of the present disclosure generally relate to systems and methods for image processing, and more specifically, for processing images or videos for compression or decompression.

### 2. Discussion of Related Art

Image compression may be applied to images to reduce the size of the image, allowing for greater efficiency in storage or transmission. Compression may be implemented using lossy or lossless compression techniques. Lossless compression may be used for medical imaging or technical drawings, whereas lossy compression may be more suitable for images where loss of fidelity is more acceptable. Lossless compression may result in less reduction of image size as compared to lossy compression, however, lossy compression may introduce compression artifacts into the image which may be perceivable.

### SUMMARY

Certain aspects of the present disclosure are directed towards a method for image compression. The method generally includes: dividing an image into at least a first region and a second region, wherein the first region and the second region comprise irregular shaped regions, selecting a first compression technique to be applied to the first region and a second compression technique to be applied to the second region, the first compression technique being different than the second compression technique, and compressing the first region using the first compression technique and the second region using the second compression technique.

Certain aspects of the present disclosure are directed towards a method for image decompression. The method generally includes: receiving at least a first region of an image and a second region of the image, wherein the first region and the second region comprise irregular shaped regions; selecting a first decompression technique to be applied to the first region and a second decompression technique to be applied to the second region, the first decompression technique being different than the second decompression technique; and decompressing the first region using the first decompression technique and the second region using the second decompression technique.

Certain aspects of the present disclosure are directed towards a non-transitory computer-readable medium storing instructions that, when executed by one or more processors, cause the one or more processors to: divide an image into at least a first region and a second region, wherein the first region and the second region comprise irregular shaped regions; select a first compression technique to be applied to the first region and a second compression technique to be applied to the second region, the first compression technique being different than the second compression technique; and compress the first region using the first compression technique and the second region using the second compression technique.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example computing device, in accordance with certain aspects of the present disclosure.

FIG. 2 is a block diagram illustrating example techniques for video streaming between a video transmitter and a video receiver using different compressors, in accordance with certain aspects of the present disclosure.

FIG. 3 is a block diagram illustrating example techniques for video streaming between a video transmitter and a video receiver using different compression configurations, in accordance with certain aspects of the present disclosure.

FIG. 4 illustrates contours of objects in a video to generate multiple video regions for compression, in accordance with certain aspects of the present disclosure.

FIG. 5 is a flow diagram illustrating example operations for image compression, in accordance with certain aspects of the present disclosure.

FIG. 6 is a flow diagram illustrating example operations for image decompression, in accordance with certain aspects of the present disclosure.

FIG. 7 illustrates a four-connected set of points.

FIG. 8 illustrates an image having regions compressed using different techniques, in accordance with certain aspects of the present disclosure.

It will be apparent to one skilled in the art after review of the entirety disclosed that the steps illustrated in the figures listed above may be performed in other than the recited order, and that one or more steps illustrated in these figures may be optional.

### DETAILED DESCRIPTION

Certain aspects of the present disclosure are directed to methods and systems for image or video compression for storage of video streaming (e.g., streaming of movies, shows, or education material). In some aspects, the system geometrically separates content in an image or video into multiple areas or regions. As used herein, a region may be any subset of elements (e.g., points, voxels or pixels) of an image or video. The region may overlap with natural objects or shapes but may also be distinct and only encompass elements that share a certain likeness (e.g., having a similar range of intensity values).

Some of the regions may be stored (e.g., such as high focus areas) with high quality and other regions may be stored with high efficiency (e.g., low quality), enabling a reduction in data size for storage or streaming. The aspects described herein facilitate a size reduction using compression of more than eight times as compared to conventional compression implementations (e.g., using x264 compression-decompression (CODEC)), with little to no discernible loss of quality.

Video streaming occupies a large portion of broadband traffic worldwide. Improvement on bandwidth usage with little to no perceivable loss of quality may yield large cost savings or better service quality such as the ability to stream 8K video instead of 4K video using the same bandwidth. For instance, each image of a video may be split into multiple regions (e.g., irregularly shaped regions) and different compression techniques may be applied to compress those regions for video streaming. As used herein, an irregular shape may refer to any polygon with five or more sides where at least two of the sides have varying lengths. An irregular shape may also be a shape with no sides (e.g., having a curved perimeter) other than a circle. The splitting of the images may be performed using any contouring technique. For example, any suitable contouring technique may be used to determine a rough outline of an object in the image or video as one region, where the background is another region of the image or video. The system may apply a greater level of compression to the background region as compared to the region defining the object.

In some aspects, a single video stream may be split into regions for processing and streamed via multiple techniques (e.g., multiple CODECs and/or compression configurations or parameters). Planar groups of frames (e.g., regions of frames) may be separated based on visual or encoding characteristics and with 3D contours, grouped 2D contours, or bitmasks. Each group may be compressed with different parameters using an existing CODEC and/or by applying a separate CODEC entirely to different groups of frames or regions. Once different groups or regions are compressed and streamed, a decoder at a receiver may overlay contoured regions based on respective encoding schemes.

A contouring and thresholding technique may be used to split or divide an image into regions. A 2-layer encoding may be used to provide regions associated with a foreground and a background. The regions may be encoded on streams using different parameterizations of a CODEC (e.g., x264 CODEC). For instance, a constant rate factor (CRF) of 15 may be used to compress the foreground and a CRF of 25 may be used to compress the background (e.g., with all other parameters being constant). The lower the CRF, the better the quality but the higher the file size. A CRF of 15 gives visually lossless compression at the cost of larger file sizes compared to a CRF of 25. However, since the high-focus areas are compressed using CRF of 15, the loss of quality with CRF of 25 in the background is not perceptible. Two streams may be overlaid into one video stream to get a single video stream that may be viewed with no discernible loss of quality compared to the standard encoded video.

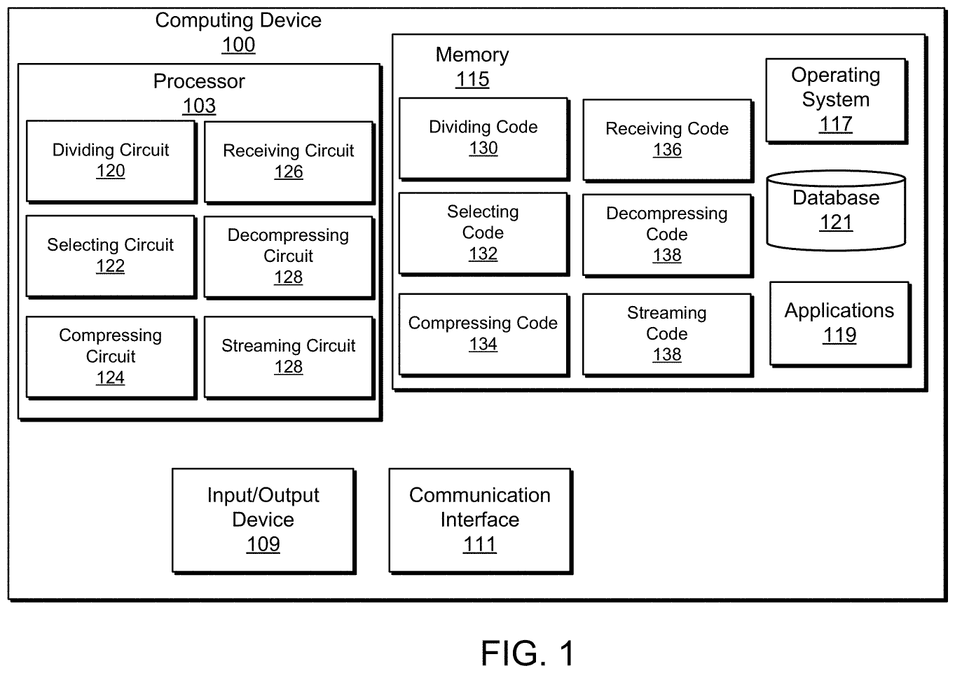

FIG. 1 illustrates an example computing device 100, in accordance with certain aspects of the present disclosure. The computing device 100 can include a processor 103 for controlling overall operation of the computing device 100 and its associated components, including input/output device 109, communication interface 111, and/or memory 115. A data bus can interconnect processor(s) 103, memory 115, I/O device 109, and/or communication interface 111.

Input/output (I/O) device 109 can include a microphone, keypad, touch screen, and/or stylus through which a user of the computing device 100 can provide input and can also include one or more of a speaker for providing audio output and a video display device for providing textual, audiovisual, and/or graphical output. Software can be stored within memory 115 to provide instructions to processor 103 allowing computing device 100 to perform various actions. For example, memory 115 can store software used by the computing device 100, such as an operating system 117, application programs 119, and/or an associated internal database 121. The various hardware memory units in memory 115 can include volatile and nonvolatile, removable, and non-removable media implemented in any method or technology for storage of information such as computer-readable instructions, data structures, program modules or other data. Memory 115 can include one or more physical persistent memory devices and/or one or more non-persistent memory devices. Memory 115 can include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Communication interface 111 can include one or more transceivers, digital signal processors, and/or additional circuitry and software for communicating via any network, wired or wireless, using any protocol as described herein. Processor 103 can include a single central processing unit (CPU), which can be a single-core or multi-core processor (e.g., dual-core, quad-core, etc.), or can include multiple CPUs. Processor(s) 103 and associated components can allow the computing device 100 to execute a series of computer-readable instructions to perform some or all of the processes described herein. Although not shown in FIG. 1, various elements within memory 115 or other components in computing device 100, can include one or more caches, for example, CPU caches used by the processor 103, page caches used by the operating system 117, disk caches of a hard drive, and/or database caches used to cache content from database 121. For implementations including a CPU cache, the CPU cache can be used by one or more processors 103 to reduce memory latency and access time. A processor 103 can retrieve data from or write data to the CPU cache rather than reading/writing to memory 115, which can improve the speed of these operations. In some examples, a database cache can be created in which certain data from a database 121 is cached in a separate smaller database in a memory separate from the database, such as in RAM or on a separate computing device. For instance, in a multi-tiered application, a database cache on an application server can reduce data retrieval and data manipulation time by not needing to communicate over a network with a back-end database server. These types of caches and others can be included in various implementations and can provide potential advantages in certain implementations of software deployment systems, such as faster response times and less dependence on network conditions when transmitting and receiving data.

Referring to FIG. 1, the processor 103 and/or memory 115 may be used to implement image or video processing (e.g., compression and decompression). For example, processor 103 may include circuit 120 for dividing. Circuit 120 may divide an image or video into multiple regions for separate compression. In some cases, processor 103 may include circuit 126 for receiving multiple regions of an image or video for decompression. The processor 103 may also include a circuit 122 for selecting. For example, circuit 122 may select different compression or decompression techniques for compressing or decompressing the different regions. As shown, processor 103 may include circuit 124 for compressing and circuit 128 for decompressing. In some cases, the processor 103 may include circuit 128 for streaming.

The memory 115 may be coupled to processor 103 and may store code which, when executed by processor 103, performs the operations described herein. For example, the memory 115 may include code 130 for dividing, code 132 for selecting, code 134 for compressing, code 136 for receiving, code 138 for decompressing, and code 138 for streaming.

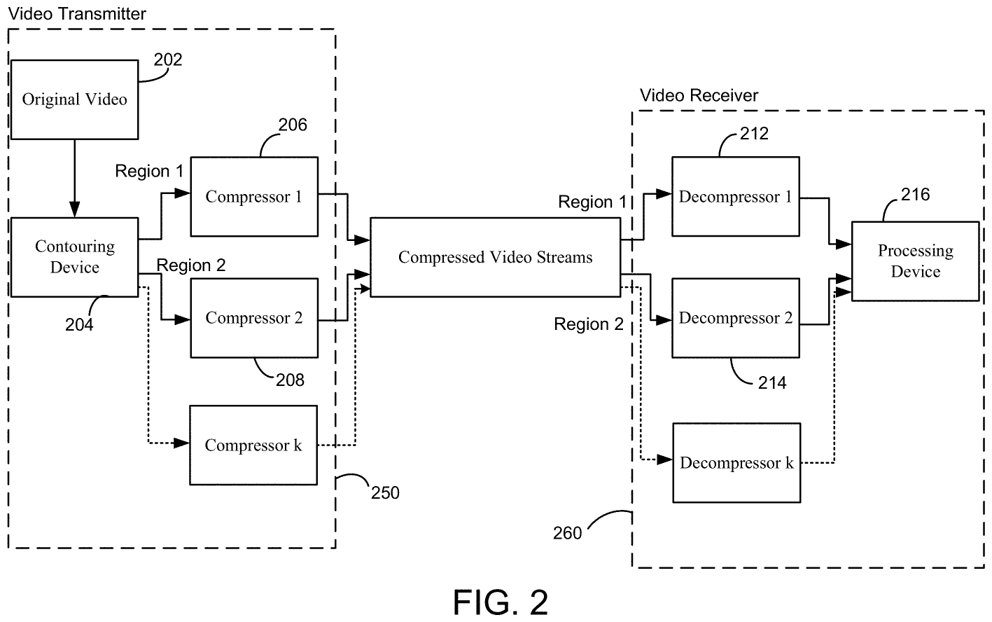

FIG. 2 is a block diagram illustrating example techniques for video streaming between a video transmitter 250 and a video receiver 260 using different compressors and decompressors, in accordance with certain aspects of the present disclosure. The video transmitter 250 may include a contouring device 204. An original video 202 may be received by the contouring device 204. The original video 202 may be generated by a processor, such as the processor 103 described with respect to FIG. 1. The contouring device 204 may use any contouring or threshold technique to detect a contour of one or more objects in the original video. Based on the contour, multiple regions (e.g., region 1 and region 2) of the video may be identified. For example, a foreground in the video may be identified as one region and a background in the video may be identified as another region. The foreground in the video may be provided to the compressor 206 for compression and the background of the video may be provided to the compressor 208 for compression. The compressor 206 and compressor 208 may be part of different CODECs, in some implementations. Once compressed, the compressed video regions (e.g., compressed region 1 and compressed region 2) may be streamed from the video transmitter 250 to the video receiver 260, as shown. For example, the compressed regions of the video from the compressors may be streamed using different (e.g., separate) video streams.

Upon reception at the video receiver 260, the compressed region 1 may be decompressed using decompressor 212 and the compressed region 2 may be decompressed using decompressor 214. Once decompressed, video regions may be provided to a processing device 216 to generate a video output (e.g., corresponding to the original video 202). In some cases, the compressor 206 and decompressor 212 may form a first CODEC, and the compressor 208 and decompressor 214 may form a second CODEC. While some examples provided herein are described with two compressors or two decompressors to facilitate understanding, the aspects of the present disclosure may be implemented with any number of compressors or decompressors. For example, as shown in FIG. 2, there may be k compressors and k decompressors, k being any integer greater than two.

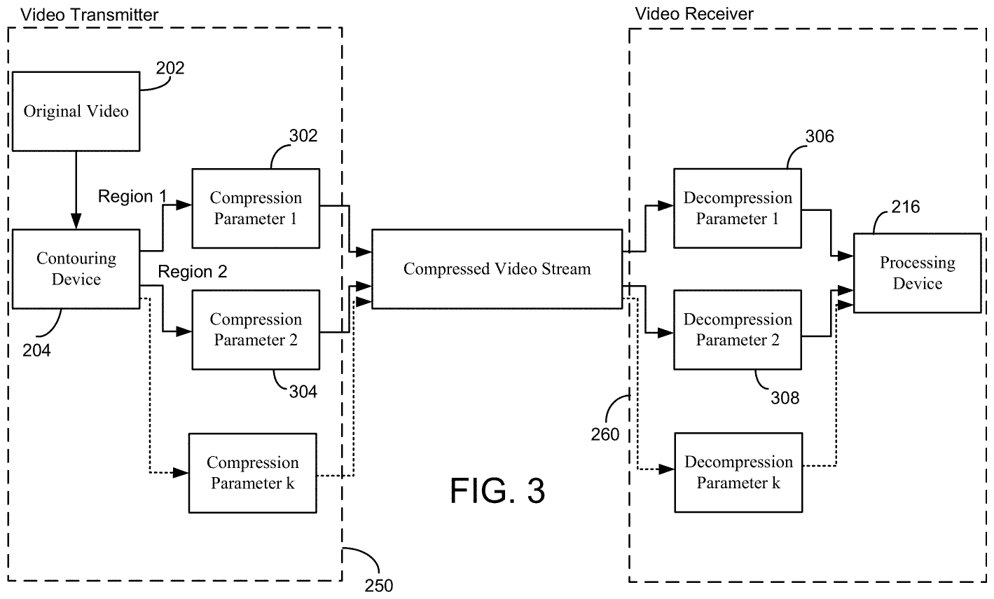

FIG. 3 is a block diagram illustrating example techniques for video streaming between a video transmitter 250 and a video receiver 260 using different compression configurations (e.g., parameters), in accordance with certain aspects of the present disclosure. As shown, upon dividing an image or video into regions, the regions may be compressed using different compression parameters, which may be associated with the same CODEC or different CODECs. For example, at block 302, a CODEC may compress region 1 using compression parameter 1, and at block 304, the same CODEC (or a different CODEC) may compress region 2 using compression parameter 2. In some implementations, the compressed regions may be overlaid on a single video stream and provided to video receiver 260. One or more CODECs of the video receiver 260 decompresses the regions. For example, at block 306, the CODEC may decompress the compressed region 1 using decompression parameter 1, and at block 308, the CODEC (or a different CODEC) may decompress the compressed region 2 using decompression parameter 2. The decompressed regions may be provided to the processing device 216 for generating a video output, as described herein.

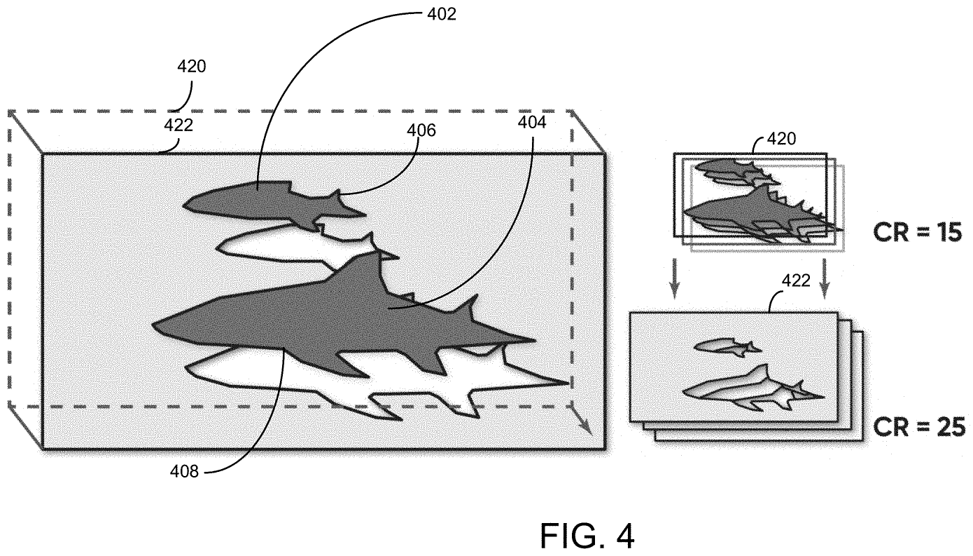

FIG. 4 illustrates contours of objects in a video to generate multiple video regions for compression, in accordance with certain aspects of the present disclosure. A video may have objects 402, 404, such as images of sharks as shown. Any suitable contouring technique may be used to identify contours of the objects. For example, a contour 406 may be identified for object 402 and a contour 408 may be identified for object 404. Based on the contours, multiple regions (or layers 420, 422) may be generated. For example, layer 420 may include the foreground having the objects 402, 404 inside contours 406, 408, respectively. Layer 422 may include the background (e.g., of the ocean in this example). As described, the different layers or regions may be compressed using different parameters, and in some cases, different CODECs. The foreground captured by layer 420 may be compressed using a CRF of 15, providing a visually lossless compression at the cost of larger file sizes. In contrast, layer 422 may be compressed using a CRF of 25, providing greater compression for a smaller file size. The contours of the objects may not be exact, but rather a rough outline of objects to facilitate efficient processing. As shown, each image and layer may be part of multiple images or layers that form a video.

While some examples provided herein have described dividing a video into two regions to facilitate understanding, the aspects of the present disclosure may be implemented for any suitable number of regions. For example, a video may be divided into k regions, k being any positive integer. The k regions may be compressed using k number of CODECs, the same CODEC but with k number of compression configurations (e.g., parameters), or using k CODECs along with k different compression configurations. For example, as shown in FIG. 2, there may be k compressors and k decompressors, and as shown in FIG. 3, there may be k compression parameters and k decompression parameters.

In some aspects, the techniques described herein may be used to compress images for efficient storage. For example, the techniques described herein may be used to compress biomedical images. Typically, biomedical images may be stored in regular containing shapes such as rectangles or circles. However, biomedical images often assume an irregular form. Thus, there is a discrepancy between the storage format and the content stored. Furthermore, biomedical images are often characterized by locally continuous intensities that are more homogeneous than they are across the entire image. Some aspects of the present disclosure use irregular image representation based on geometric contours to provide efficient compression and storage of images.

Two or more compression schemes (techniques) may be applied for arbitrary regions of an image at a per-pixel resolution (e.g., contour). For example, entropy encoding may be applied to noisy background regions, while multiple predictive schemes may be used to encode foreground elements. Second, local homogeneity may be used to offer context-dependent compression across disparate regions of a single image. Separate regions may be encoded separately and reversible histogram packing may be applied to those regions such that the entropy of included intensities may be reduced. The techniques described herein may be used for compression of high bit-depth and/or high-resolution bioimages where regions are larger and have more disparate characteristics.

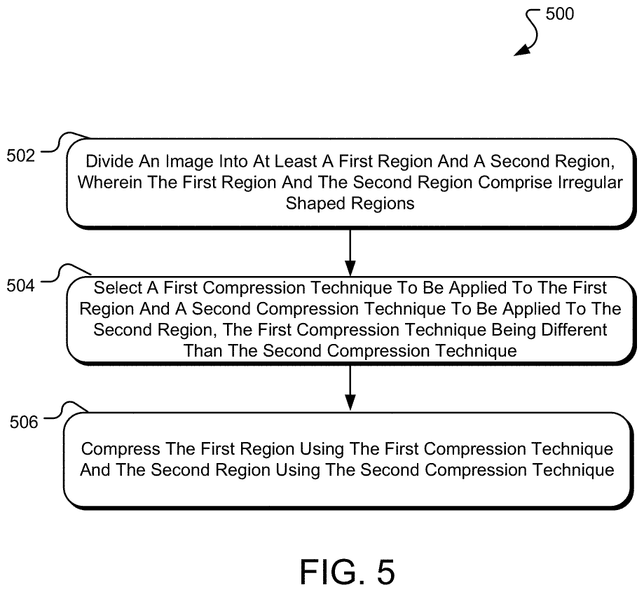

FIG. 5 is a flow diagram illustrating example operations 500 for image compression, in accordance with certain aspects of the present disclosure. The operations 500 may be performed, for example, by a processing system such as the processor 103, and in some cases, memory 115 shown in FIG. 1.

At block 502, the processing system may divide (e.g., via circuit 120 for dividing) an image into at least a first region and a second region. The first region and the second region may include irregular shaped regions. The image may be divided based on contour detection of one or more objects in the image. For example, dividing the image may include identifying a contour of an object in the image. The first region may include a region inside the contour of the object, and the second region may include a region outside the contour of the object. The image may be divided using a thresholding technique, a machine learning model (e.g., which may be trained to identify features in an image or video), or based on user data (e.g., eye tracking data may be used to identify a feature being focused on by the user which may be extracted as a region for lossless compression). In some aspects, the first region may include a first finite set of image elements and the second region may be a second finite set of image elements. The second finite set of image elements may overlap with the first set of finite set of image elements, in some cases. A region may include connected components of image elements. Image elements may be represented by multiple contours and/or the intersection of multiple contours to construct one or more regions.

At block 504, the processing system may select (e.g., via circuit 122 for selecting) a first compression technique to be applied to the first region and a second compression technique to be applied to the second region, the first compression technique being different than the second compression technique. In some aspects, the first compression technique is associated with a first CRF, and the second compression technique is associated with a second CRF, the first CRF being different than the second CRF. For instance, the first region may be associated with a foreground of the image, and the second region may be associated with a background of the image. In this case, the first CRF associated with compression of the foreground may be less than the second CRF associated with compression of the background.

In some aspects, image may be part of a video. Compressing the first region using the first compression technique may involve using a first compressor (e.g., compressor 206) associated with a first CODEC to compress the first region of the video. Compressing the second region using the second compression technique may involve using a second compressor (e.g., compressor 208) associated with a second CODEC to compress the second region of the video, the first CODEC being different than the second CODEC.

In some aspects, compressing the first region using the first compression technique may involve using a first compression configuration (e.g., compression parameter 1 shown in FIG. 3) via a CODEC to compress the first region of the video. Compressing the second region using the second compression technique may involve using a second compression configuration (e.g., compression parameter 2 shown in FIG. 3) via the CODEC to compress the second region of the video.

At block 506, the processing system may compress (e.g., via circuit 124 for compressing) the first region using the first compression technique and the second region using the second compression technique. In some aspects, the image is part of a video. The processing system may stream (e.g., via circuit 128 for streaming) the video using a first video stream including the first region as compressed using the first compression technique and a second video stream including the second region as compressed using the second compression technique, the first video stream being separate from the second video stream. In some aspects, the processing system may store (e.g., in memory 115, such as in database 121) the compressed first region and the compressed second region.

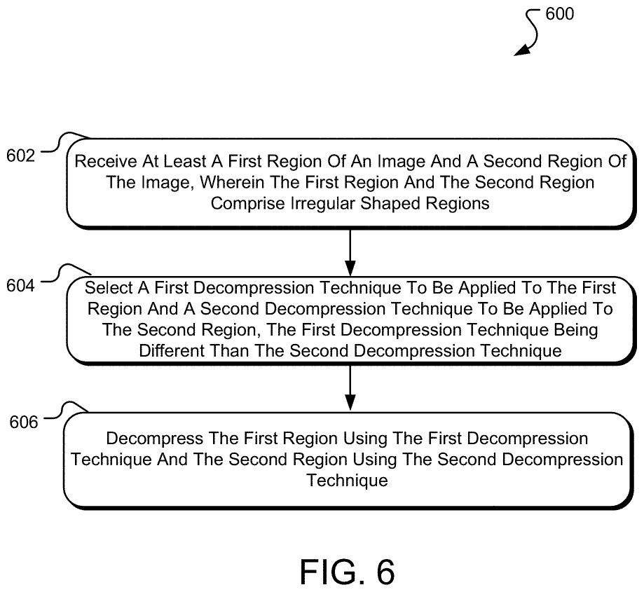

FIG. 6 is a flow diagram illustrating example operations 600 for image decompression, in accordance with certain aspects of the present disclosure. The operations 600 may be performed, for example, by a processing system such as the processor 103, and in some cases, memory 115 shown in FIG. 1.

At block 602, the processing system may receive (e.g., via circuit 126 for receiving) at least a first region of an image and a second region of the image. The first region and the second region may be irregular shaped regions. In some aspects, the image is part of a video. In this case, receiving the first region and the second region may include receiving a first video stream including the first region and a second video stream including the second region, the first video stream being separate from the second video stream.

At block 604, the processing system may select (e.g., via circuit 122 for selecting) a first decompression technique to be applied to the first region and a second decompression technique to be applied to the second region, the first decompression technique being different than the second decompression technique. The first decompression technique may be associated with a first CRF, and the second decompression technique may be associated with a second CRF, the first CRF being different than the second CRF. For example, the first region may be associated with a foreground of the image, and the second region may be associated with a background of the image. In this case, the first CRF associated with decompression of the foreground may be less than the second CRF associated with decompression of the background.

At block 606, the processing system may decompress (e.g., via circuit 128 for decompression) the first region using the first decompression technique and the second region using the second decompression technique. In some aspects, the image is part of a video. Decompressing the first region using the first decompression technique may involve using a first decompressor (e.g., decompressor 212) associated with a first CODEC to decompress the first region of the video. Decompressing the second region using the second decompression technique may involve using a second decompressor (e.g., decompressor 214) associated with a second CODEC to decompress the second region of the video, the first CODEC being different than the second CODEC.

In some aspects, decompressing the first region using the first decompression technique may involve using a first decompression configuration (e.g., decompression parameter 1 shown in FIG. 3) via a CODEC to decompress the first region of the video. Decompressing the second region using the second decompression technique may involve using a second decompression configuration (e.g., decompression parameter 2 shown in FIG. 3) via the CODEC to decompress the second region of the video.

While certain examples provided herein are described for 2D implementations (e.g., processing of an image) to facilitate understanding, the aspects described herein are applicable for 2D implementations (e.g., an image), 3D implementations (e.g., a 3D space capture), 4D implementations (e.g., 3D space plus time), 5D implementations (e.g., 3D space+time+colors) and so on. For example, for a 3D implementation, a region may have x, y, and z dimensions. For a 4D implementation, different compression or decompression techniques may be applied for a region having x, y, and z dimensions and for a certain period (e.g., a time period of a video). For a 5D implementation, different compression or decompression techniques may be applied for a region having x, y, and z dimensions, for a certain period, and certain colors.

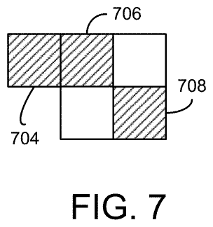

As used herein, processing data (e.g., compressing or decompressing) may include processing elements (e.g., pixels/voxels) from an image of two or more dimensions and one or more channels (e.g., a video includes a temporal dimension). Elements form a connected component based on their local neighbors of the same label (e.g., four-connected in 2D and six-connected in 3D). FIG. 7 illustrates a four-connected set of points. For example, points 704, 706 (e.g., pixels) may be included as part of a four-connected point region since point 704 has two vertices connected to two vertices of point 706. On the other hand, point 708 may not be included as part of the four-connected pixel region since point 708 only has one vertex connected to one vertex of point 706. The same concept is applicable to 3D implementations, but with six-connected point regions.

The outer perimeter of a connected component may be represented by a contour. A connected component can be represented by one or more contours, where a connected component with holes (e.g., fully contained elements of another label) may subtract one or more inner area(s) from the outer area defined by the contour. A region may be a group of connected components, a set of image elements, a group of (e.g., not necessarily connected) image elements, or an image partition/segmentation. A region can contain a single object or multiple objects, be defined by a set of image elements with similar characteristics, be manually defined, or arbitrarily defined. Regions are compressed/decompressed with different CODECs and/or compression schemes/configurations. A region can be fully represented by the area enveloped by a contour, and a region can be fully represented by a connected component. A region may be comprised of one or more irregular connected components which are constructed using one or more contours.

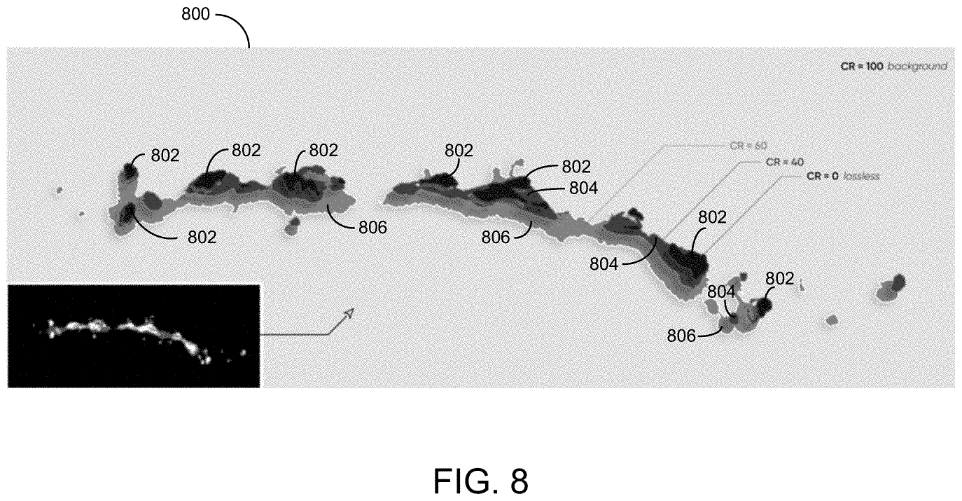

FIG. 8 illustrates an image 800 having regions compressed using different techniques, in accordance with certain aspects of the present disclosure. As shown, one region may be surrounded by another region. For example, the image 800 may include region 802 which may be compressed using CR of 0 (e.g., lossless compression), region 804 which may be compressed using CR of 40, and region 806 which may be compressed using CR of 60. As shown, the regions 802, 804, 806 may include elements or areas that are not connected. Various contours may exist in a region, which may intersect and overlap. For example, a region may be represented by an intersection of one set of the contours and another region may be represented by an intersection of another set of the contours.

These and various other arrangements will be described more fully herein. As will be appreciated by one of skill in the art upon reading the following disclosure, various aspects described herein can be a method, a computer system, or a computer program product. Accordingly, those aspects can take the form of an entirely hardware implementation, an entirely software implementation, or at least one implementation combining software and hardware aspects. Furthermore, such aspects can take the form of a computer program product stored by one or more computer-readable storage media (e.g., non-transitory computer-readable medium) having computer-readable program code, or instructions, included in or on the storage media. Any suitable computer-readable storage media can be utilized, including hard disks, CD-ROMs, optical storage devices, magnetic storage devices, and/or any combination thereof. In addition, various signals representing data or events as described herein can be transferred between a source and a destination in the form of electromagnetic waves traveling through signal-conducting media such as metal wires, optical fibers, and/or wireless transmission media (e.g., air and/or space).

Implementations of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an implementation in the present disclosure can be references to the same implementation or any implementation; and, such references mean at least one of the implementations.

Reference to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation, nor are separate or alternative implementations mutually exclusive of other implementations. Moreover, various features are described which may be exhibited by some implementations and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various implementations given in this specification.

Without intent to limit the scope of the disclosure, examples of instruments, apparatus, methods and their related results according to the implementations of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

We claim:

1. A method for image compression, comprising:
dividing an image into at least a first region and a second region, wherein the first region and the second region comprise irregular shaped regions;
selecting a first compression technique to be applied to the first region and a second compression technique to be applied to the second region, the first compression technique being different than the second compression technique; and
compressing the first region using the first compression technique and the second region using the second compression technique.

2. The method of claim 1, wherein dividing the image comprises identifying a contour of one or more features in the image, wherein the first region comprises a region inside the contour, and wherein the second region comprises a region outside the contour.

3. The method of claim 1, wherein dividing the image comprises identifying contours to represent one or more features in the image, wherein the first region is represented by an intersection of one set of the contours and the second region is represented by an intersection of another set of the contours.

4. The method of claim 1, wherein:
the image is one of multiple images of a video;
compressing the first region using the first compression technique comprises using a compressor associated with a first compression-decompression (CODEC) to compress the first region of the video; and
compressing the second region using the second compression technique comprises using a compressor associated with a second CODEC to compress the second region of the video, the first CODEC being different than the second CODEC.

5. The method of claim 1, wherein:
the image is one of multiple images of a video;
compressing the first region using the first compression technique comprises using a first compression configuration via a CODEC to compress the first region of the video; and
compressing the second region using the second compression technique comprises using a second compression configuration via the CODEC to compress the second region of the video.

6. The method of claim 1, wherein the first compression technique is associated with a first constant rate factor (CRF), wherein the second compression technique is associated with a second CRF, the first CRF being different than the second CRF.

7. The method of claim 6, wherein the first region is associated with a foreground of the image, wherein the second region is associated with a background of the image, and wherein the compression of the foreground is less lossy than the compression of the background.

8. The method of claim 1, wherein the image is divided based on contour detection of one or more objects in the image.

9. The method of claim 1, wherein the image is one of multiple images of a video, the method further comprising streaming the video using a first video stream including the first region as compressed using the first compression technique and a second video stream including the second region as compressed using the second compression technique, the first video stream being separate from the second video stream.

10. The method of claim 1, wherein the image is divided using a thresholding technique.

11. The method of claim 1, wherein the image is divided based on data associated with a user.

12. The method of claim 1, wherein the image is divided using a trained machine learning model.

13. The method of claim 1, further comprising storing the compressed first region and the compressed second region.

14. A method for image decompression, comprising:
receiving at least a first region of an image and a second region of the image, wherein the first region and the second region comprise irregular shaped regions;
selecting a first decompression technique to be applied to the first region and a second decompression technique to be applied to the second region, the first decompression technique being different than the second decompression technique; and
decompressing the first region using the first decompression technique and the second region using the second decompression technique.

15. The method of claim 14, wherein:
the image is one of multiple images of a video;
decompressing the first region using the first decompression technique comprises using a decompressor associated with a first compression-decompression (CODEC) to decompress the first region of the video; and
decompressing the second region using the second decompression technique comprises using a decompressor associated with a second CODEC to decompress the second region of the video, the first CODEC being different than the second CODEC.

16. The method of claim 14, wherein:
the image is one of multiple images of a video;
decompressing the first region using the first decompression technique comprises using a first decompression configuration via a CODEC to decompress the first region of the video; and
decompressing the second region using the second decompression technique comprises using a second decompression configuration via the CODEC to decompress the second region of the video.

17. The method of claim 14, wherein the first decompression technique is associated with a first constant rate factor (CRF), wherein the second decompression technique is associated with a second CRF, the first CRF being different than the second CRF.

18. The method of claim 17, wherein the first region is associated with a foreground of the image, wherein the second region is associated with a background of the image, and wherein the foreground compressed using a less lossy compression technique than the background.

19. The method of claim 14, wherein the image is part of multiple images of a video, wherein receiving the first region and the second region comprises receiving a first video stream including the first region and a second video stream including the second region, the first video stream being separate from the second video stream.

20. A non-transitory computer-readable medium storing instructions that, when executed by one or more processors, cause the one or more processors to:
divide an image into at least a first region and a second region, wherein the first region and the second region comprise irregular shaped regions;
select a first compression technique to be applied to the first region and a second compression technique to be applied to the second region, the first compression technique being different than the second compression technique; and
compress the first region using the first compression technique and the second region using the second compression technique.
